(19) United States
(12) Patent Application Publication
(10) Pub. No.: US 2016/0243661 A1
(43) Pub. Date: Aug. 25, 2016

(54) MACHINE TOOL

(71) Applicant: FANUC Corporation, Yamanashi (JP)

(72) Inventor: Rikizou WATANABE, Yamanashi (JP)

(21) Appl. No.: 15/047,634

(22) Filed: Feb. 19, 2016

(30) Foreign Application Priority Data
Feb. 20, 2015 (JP) 2015-31652

(51) Int. Cl. B23Q 3/157; B23Q 11/10; B23Q 3/155

(52) U.S. Cl. CPC B23Q 3/1572; B23Q 3/1554; B23Q 11/10

(57) ABSTRACT

A machine tool which includes a main axis head which supports a main axis so that the main axis is freely rotatable and which moves vertically, a turret tool exchanging device to which a plurality of grips are provided on a circumference thereof, which is capable of holding a plurality of tools attached to the main axis respectively by the grips, and which is supported around a predetermined rotating axis in a freely rotatable manner, and a turning tool holder attachment unit which attaches a turning tool holder holding a turning tool thereto so that the turning tool holder is detachable, and in which the turning tool holder attachment unit is fixed so as not to change a position and a posture thereof with respect to the main axis head.

### BACKGROUND OF THE INVENTION

1. Field of the Invention

The present invention relates to a machine tool, and especially relates to a machine tool provided with a turning tool holder attachment unit.

2. Description of the Related Art

FIG. 1 illustrates a table-moving type turret machine tool. A main axis head 2 which is supported in a manner to be movable in a axis direction (a Z direction, a vertical direction in the drawing) of a main axis 7 is attached to a column 1 with a linear motion guide 9 interposed. To the main axis head 2, a main axis unit 8 is attached. To the main axis 7 provided to the main axis unit 8, various types of tools 4 which can be exchanged by a tool exchanging device (turret) 3 are attached. The tool 4 rotates in a various rotating speed along with the main axis 7 and makes various relative movements in accordance with a type of machining with respect to a workpiece 6 which is fixed on a table 5 so as to perform machining (refer to Japanese Patent Application Laid-Open No. 2004-74335). The table 5 is supported in a manner to be movable in two directions which are orthogonal to a direction of the main axis 7 and are orthogonal to each other (X and Y directions, a horizontal direction in the drawing and a direction vertical to a plane of the drawing).

While the tool 4 cuts the workpiece 6, an opening-closing door 11 which is provided to a splash guard 10 is closed and cutting fluid which is supplied from a cutting fluid tank 13b through a cutting fluid hose 12 by a cutting fluid pump 13 is discharged from a nozzle 12b which is attached to an end portion of a cutting fluid hose 12 toward the tool 4 which is attached to the main axis 7 and is rotating. The cutting fluid flowing out from a machined portion in a liquid fashion flows downward along an inner wall of the splash guard 10 to be collected into a cutting fluid tank which is not illustrated. The cutting fluid in a fine mist fashion is sent to a duct 14, which is provided to an upper portion of the machine, with air which is sucked into the splash guard 10 from an opening portion which is provided on a lower portion of the machine.

There is a case where turning and grinding are performed by a turret machine tool. In this case, such method has been generally employed that a rotating device which rotates the workpiece 6 is attached onto the table 5 and a turning tool is attached to the main axis 7 of the turret machine tool so as to perform machining of the workpiece.

On the other hand, Japanese Patent Application Laid-Open No. 2012-210681 discloses a technique in which turning can be performed in such manner that a turning tool is fixed on a main axis head, which moves in synchronization with a main axis, without attaching the turning tool to the main axis in a column-moving type turret machine tool which is capable of moving the main axis head to an arbitrary position on a base by controlling driving of respective motors in X, Y, and Z directions. The machine tool disclosed in Japanese Patent Application Laid-Open No. 2012-210681 is provided with a base which is disposed on a floor surface, a carriage which is provided on the base with a Y direction moving device interposed, a column which is provided on the carriage with an X direction moving device interposed, and a main axis head which is provided on a front surface of the column with a Z direction moving device interposed.

A machining method using a turning tool to a main axis is generally employed for turning by a turret machine tool, and a feeding speed has been recently raised along with progress of a turning tool. However, there is such problem in performing high-speed machining that machining only by light cutting can be performed in machining in which a turning tool is attached to a main axis.

Further, in the turret machine tool disclosed in Japanese Patent Application Laid-Open No. 2012-210681, a turning tool is fixed to the main axis head by a fixation means and the fixation means moves with respect to the main axis head so as to prevent interference between the turning tool and a workpiece and reduction in a machining region in which a workpiece is machined. However, there have been such problems that the configuration of the machine tool is complicated and cutting fluid cannot be supplied to a tip of the turning tool.

Further, a use of a holding tool which holds a turning tool so that the turning tool is detachable is described in Japanese Patent Application Laid-Open No. 2012-210681 (paragraph “0047”). However, the specific configuration is not disclosed and there has been a problem in which cutting fluid cannot be supplied to a tip of the turning tool.

### SUMMARY OF THE INVENTION

In light of the above-mentioned problems of the prior art technique, an object of the present invention is to provide a machine tool in which a turning tool holder attachment unit is provided to a main axis head so as to be able to prevent increase in weight and the number of machining tools which are attached to a turret tool exchanging device and prevent reduction in a machining region in which a workpiece is machined.

Further, another object of the present invention is to provide a machine tool which is capable of supplying coolant to a tip of a turning tool.

Further, still another object of the present invention is to provide a machine tool which is capable of confirming whether a turning tool holder is brought into close contact with a turning tool holder attachment unit.

Further, yet another object of the present invention is to provide a machine tool in which the turning tool holder attachment unit is capable of clamping and unclamping the turning tool holder by hydraulic pressure control.

Further, yet another object of the present invention is to provide a machine tool in which an operation of exchanging a turning tool can be performed by a robot.

Further, yet another object of the present invention is to provide a machine tool in which the turning tool holder attachment unit does not interfere with a tool which is exchanged in tool exchange performed by the turret tool exchanging device.

A machine tool according to the present invention includes a main axis head which supports a main axis so that the main axis is freely rotatable and which moves vertically, a turret tool exchanging device to which a plurality of grips are provided on a circumference thereof, which is capable of holding a plurality of tools attached to the main axis respectively by the grips, and which is supported around a predetermined rotating axis in a freely rotatable manner, and a turning tool holder attachment unit which attaches a turning tool holder holding a turning tool thereto so that the turning tool holder is detachable, and the turning tool holder attachment unit is fixed so as not to change a position and a posture thereof with respect to the main axis head.

According to the configuration of the present invention, increase in weight and the number of machining tools which are attached to the turret tool exchanging device can be prevented and reduction in a machining region in which a workpiece is machined can be prevented.

The turning tool holder attachment unit may include hydraulic pressure insertion ports which respectively clamp and unclamp the turning tool holder. Accordingly, the turning tool holder attachment unit is capable of clamping and unclamping the turning tool holder by hydraulic pressure control.

The turning tool holder attachment unit may include a coolant insertion port for supplying coolant to a tip of the turning tool. Accordingly, coolant can be supplied to a tip of a turning tool.

The turning tool holder attachment unit may include an air insertion port for confirming close contact of the turning tool holder. Accordingly, whether the turning tool holder is brought into close contact with the turning tool holder attachment unit can be confirmed.

The turning tool holder may be attached to and detached from the turning tool holder attachment unit by a robot or a loader. Accordingly, an operation of exchanging a turning tool can be performed by the robot.

The turning tool holder attachment unit may be provided in a region in which interference is not generated in tool exchange performed by the tool exchanging device. Accordingly, the turning tool holder attachment unit can be prevented from interfering with a tool which is exchanged in tool exchange performed by the turret tool exchanging device.

### BRIEF DESCRIPTION OF THE DRAWINGS

The above-described and other objects and features of the present invention will be apparent from description of the following embodiment in reference to the accompanying drawings. Among these drawings:

FIG. 1 illustrates a turret machine tool;

FIG. 2 illustrates a state in which a turning tool holder attachment unit is fixed to a main axis head;

FIG. 3 illustrates a state in which the turning tool holder attachment unit is fixed to the main axis head and which is viewed from a lateral surface of the machine tool;

FIG. 4 illustrates piping by which the turning tool holder attachment unit and an external device are connected to each other;

FIG. 5 illustrates a clamping operation and an unclamping operation of the turning tool holder attachment unit;

FIG. 6 illustrates exchange of a turning tool holder performed with a robot; and

FIG. 7 illustrates a method for gripping a turning tool holder by a turning tool holder exchanging hand.

### DETAILED DESCRIPTION OF THE PREFERRED EMBODIMENT

An embodiment of the present invention will be described below with reference to the accompanying drawings.

As described in the background technique, examples of a turret machine tool include the table-moving type turret machine tool described in Japanese Patent Application Laid-Open No. 2004-74335, for example, and the column-moving type turret machine tool described in Japanese Patent Application Laid-Open No. 2012-210681, for example.

A turret tool exchanging device is provided with a plurality of grips on a circumference thereof so as to be capable of holding a plurality of tools which are attached to the main axis by respective grips and is supported around a predetermined rotating axis in a freely-rotatable manner.

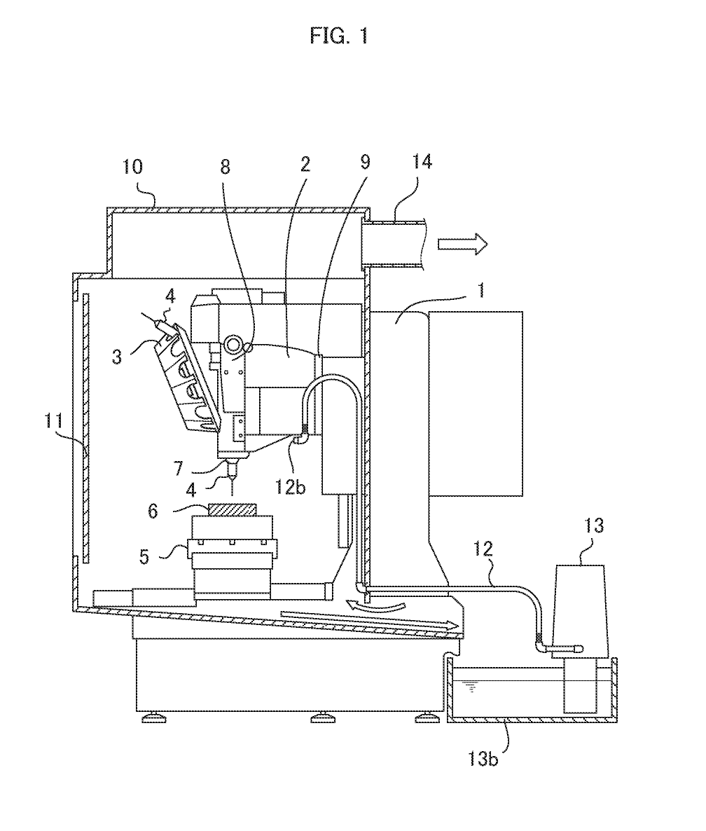

A machine tool provided with a turning tool holder attachment unit according to the present invention can be configured as either of the table-moving type turret machine tool disclosed in Japanese Patent Application Laid-Open No. 2004-74335 and the column-moving type turret machine tool disclosed in Japanese Patent Application Laid-Open No. 2012-210681. An embodiment of the present invention is described here with reference to the table-moving type turret machine tool illustrated in FIG. 1.

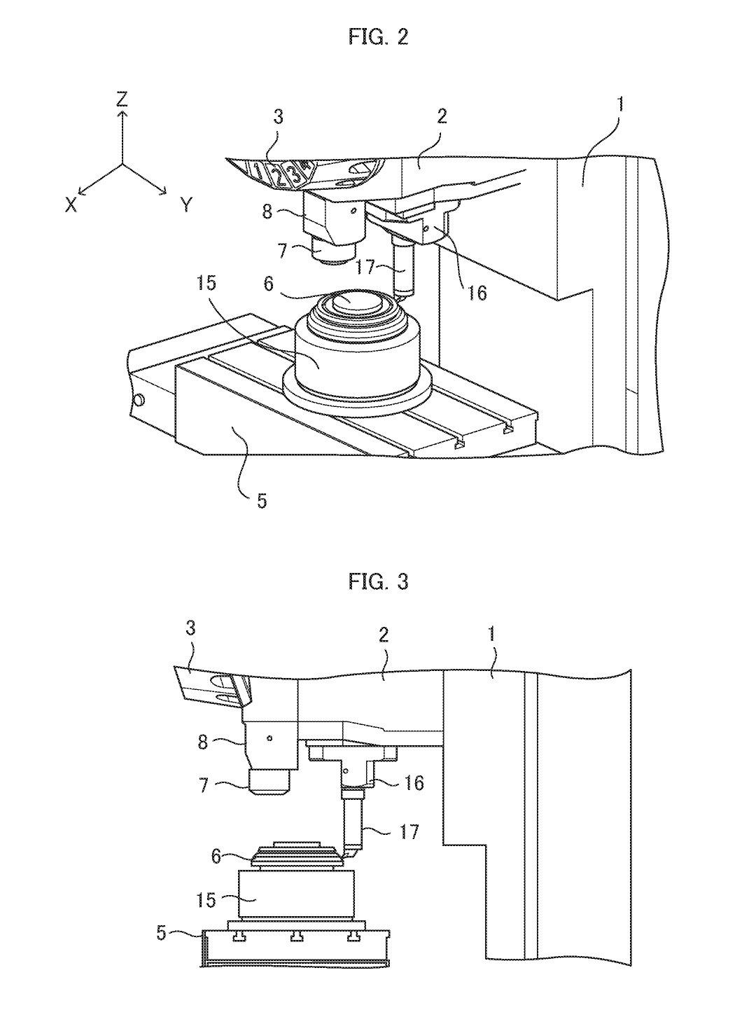

FIG. 2 illustrates a turning tool holder attachment unit which is fixed to a main axis head. Further, FIG. 3 illustrates a state in which the turning tool holder attachment unit is fixed to the main axis head and which is viewed from a lateral surface of the machine tool. A rotating table 15 is placed on the table 5. The table 5 is movable in the X and Y directions which are orthogonal to the axis direction of the main axis 7 and are orthogonal to each other. The main axis head 2 is movable in the Z direction which is the axis direction of the main axis 7. In the turret machine tool, the main axis head 2 which is supported in a manner to be vertically-movable in a axis direction (the Z direction) of the main axis 7 is attached to the column 1 with the linear motion guide 9 interposed, as illustrated in FIG. 1. Therefore, the main axis 7 and the main axis head 2 synchronously move.

In the embodiment of the present invention, a turning tool holder attachment unit 16 is attached to the main axis head 2 which moves in synchronization with the main axis 7. The turning tool holder attachment unit 16 is attached to the main axis head 2 in a region in which interference is not generated in tool exchange performed by the tool exchanging device (turret) 3 with respect to the main axis 7. The turning tool holder attachment unit 16 is attached by a fixation means such as a bolt so that a posture and a position thereof with respect to the main axis head 2 do not change. As illustrated in FIG. 2 and FIG. 3, the turning tool holder attachment unit 16 is fixed in the region in which interference is not generated in tool exchange performed by the tool exchanging device 3, that is, a region which is between the main axis 7 and a front surface of the column 1 and is below the main axis head 2.

When a turning tool holder 17 is attached to the turning tool holder attachment unit 16 to perform turning of the workpiece 6, the tool 4 is not attached to the main axis 7. On the other hand, when machining of the workpiece 6 is performed in a manner to attach the tool 4 to the main axis 7, the turning tool holder 17 is not attached to the turning tool holder attachment unit 16.

The turning tool holder attachment unit 16 is capable of clamping and unclamping the turning tool holder 17. Operations of clamping and unclamping performed by the turning tool holder attachment unit 16 can be performed by hydraulic pressure control. The configuration of the turning tool holder attachment unit 16 is described with reference to FIG. 5. To a tip of the turning tool holder 17, a tool for turning (turning tool) is attached. With the tool for turning attached to the tip of the turning tool holder 17, the workpiece 6 which is attached on the rotating table 15 can be machined by turning.

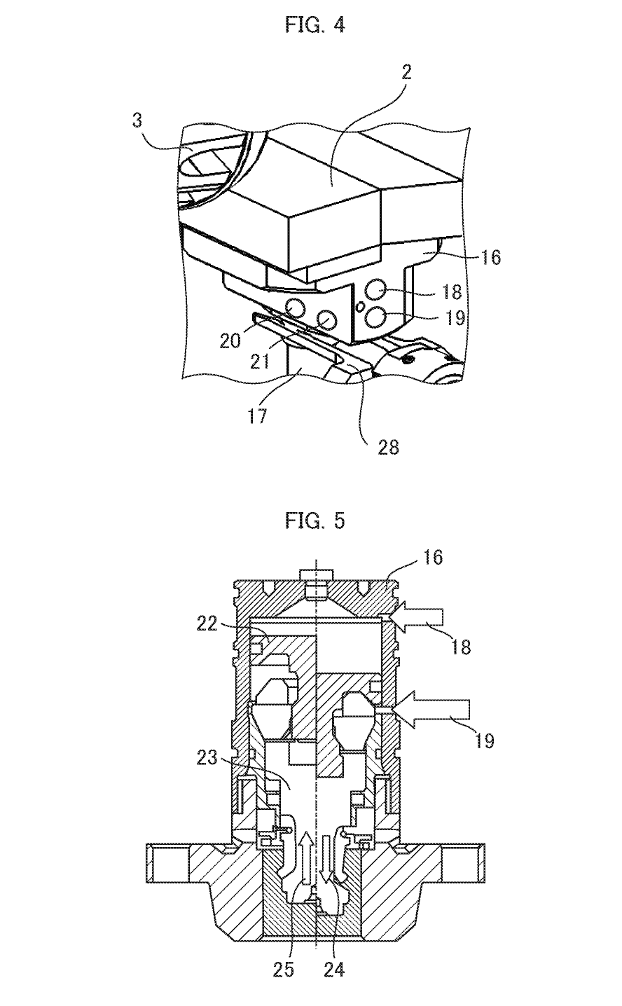

FIG. 4 illustrates piping by which the turning tool holder attachment unit and an external device are connected to each other. The turning tool holder 17 can be clamped and unclamped by supplying hydraulic pressure from a hydraulic pressure device (not illustrated) respectively from a clamping hydraulic pressure insertion port 19 and an unclamping hydraulic pressure insertion port 18 which are provided to the turning tool holder attachment unit 16.

Further, an ultra high pressure coolant insertion port 20 is provided to the turning tool holder attachment unit 16, so that high pressure coolant fluid can be supplied to a turning tool which is attached to the tip of the turning tool holder 17 via the turning tool holder attachment unit 16. Thus, a pipe for high pressure coolant is arranged in the turning tool holder attachment unit 16, so that cutting fluid (high pressure coolant) can be freely supplied to a turning tool attached to the tip of the turning tool holder 17.

Further, in order to inspect whether or not the turning tool holder 17 is properly clamped, a tool holder close-contact confirmation air insertion port 21 is provided to the turning tool holder attachment unit 16. Accordingly, close-contact confirmation can be performed by a detection signal from a pressure sensor (not illustrated).

FIG. 5 illustrates a clamping operation (a left half drawing) and an unclamping operation (a right half drawing) of the turning tool holder attachment unit. As illustrated in FIG. 5, the turning tool holder attachment unit 16 applies a hydraulic pressure from the unclamping hydraulic pressure insertion port 18 so as to move down a piston 22 and open a draw-bar 23 (an unclamping operation 24). Accordingly, the turning tool holder 17 can be detached. After exchange of the turning tool holder 17, a hydraulic pressure is applied from the clamping hydraulic pressure insertion port 19 so as to move up the piston 22 and start a clamping operation 25.

Other than the above-mentioned hydraulic pressure device, any method for fixing the turning tool holder 17 to the turning tool holder attachment unit 16 can be employed as long as the method is a known method such as a clamping method using air pressure and a manual fixing method. By attaching an exclusive cap (a dummy tool) for chip intrusion prevention to the turning tool holder attachment unit 16 after an end of machining by a turning tool, chip intrusion to the turning tool holder attachment unit 16 can be blocked and tool interference and machining area interference in cutting performed by using the main axis 7 of the turret machine tool body can be eliminated.

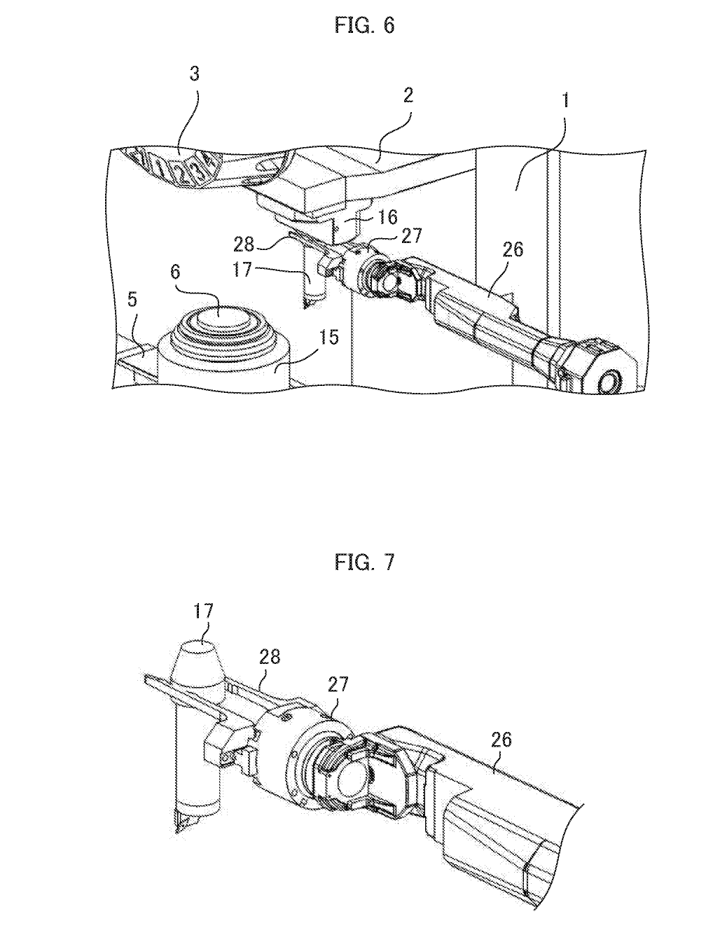

FIG. 6 illustrates exchange of a turning tool holder performed with a robot. In the turning tool holder 17, automatic tool exchange can be performed by using a robot 26 to which a turning tool holder exchanging hand 27 is attached or a loader (not illustrated). The robot 26 or the loader is disposed inside or outside the machine tool.

FIG. 7 illustrates a method for gripping a turning tool holder by a turning tool holder exchanging hand. A movable hand claw 28 is attached to a tip of the turning tool holder exchanging hand 27 which is attached to the robot 26 and accordingly, the turning tool holder 17 can be gripped. That is, the turning tool holder 17 which is housed in an external stocker (not illustrated) can be attached to the turning tool holder attachment unit 16 by the turning tool holder exchanging hand 27 of the robot 26 or the loader. The turning tool holder 17 which is attached is returned to the external stocker by the robot 26 or the loader after an end of machining and a next turning tool is selected. Thus, the same operation can be repeatedly performed.

In a turning device of the turret machine tool according to the embodiment of the present invention, the exclusive turning tool holder attachment unit 16 is provided to the main axis head 2, so that increase in weight and the number of machining tools which are attached to the tool exchanging device 3 can be prevented. Further, the turning tool holder 17 is configured to be detachable, so that limitation of a machining area is relaxed.

Further, the turning tool holder attachment unit 16 is fixed to the main axis head 2, so that a holding force of the turning tool holder 17 can be increased and accordingly, high-speed heavy cutting can be performed. Further, the high pressure coolant is supplied to a tip of a turning tool, so that heat generation of a machining tool (a turning tool) is suppressed and chip discharge is facilitated. Further, an automatic tool exchange method performed by the robot 26 or a loader is employed, so that a completely-unmanned operation can be achieved.

As a result, a tool life can be elongated and machining precision can be enhanced so as to lead reduction in a cost of a cutting tool for a machine tool (resource saving). In a step-divided machining method using a plurality of machines as a conventional machine tool, machining cannot be stably performed due to the use of a plurality of machines in terms of maintenance of machining precision, in the present condition. While, in the machine tool according to the embodiment of the present invention, all machining steps are performed by one machine, so that machining time can be shortened, a cost of mechanical appliances can be reduced, and a labor cost can be largely reduced. Further, the machine tool according to the embodiment of the present invention is an eco-friendly machine tool.

The embodiment of the present invention has been described thus far. However, the present invention is not limited to the example of the above-described embodiment, but the present invention can be embodied in other aspects by arbitrarily making alterations.

1. A machine tool comprising:
a main axis head which supports a main axis so that the main axis is freely rotatable and which moves vertically;
a turret tool exchanging device to which a plurality of grips are provided on a circumference thereof, which is capable of holding a plurality of tools, the tools being attached to the main axis, respectively by the grips, and which is supported around a predetermined rotating axis in a freely rotatable manner; and
a turning tool holder attachment unit which attaches a turning tool holder, the turning tool holder holding a turning tool, thereto so that the turning tool holder is detachable; wherein
the turning tool holder attachment unit is fixed so as not to change a position and a posture thereof with respect to the main axis head.

2. The machine tool according to claim 1, wherein the turning tool holder attachment unit includes hydraulic pressure insertion ports which respectively clamp and unclamp the turning tool holder.

3. The machine tool according to claim 1, wherein the turning tool holder attachment unit includes a coolant insertion port for supplying coolant to a tip of the turning tool.

4. The machine tool according to claim 1, wherein the turning tool holder attachment unit includes an air insertion port for confirming close contact of the turning tool holder.

5. The machine tool according to claim 1, wherein the turning tool holder can be attached to and detached from the turning tool holder attachment unit by a robot or a loader.

6. The machine tool according to claim 1, wherein the turning tool holder attachment unit is provided in a region in which interference is not generated in tool exchange performed by the tool exchanging device.
